(19) United States
(12) Patent Application Publication
(10) Pub. No.: US 2024/0278264 A1
(43) Pub. Date: Aug. 22, 2024

(54) HAND SHOWER INCLUDING A PLURALITY OF CLEANING MODES

(71) Applicant: Delta Faucet Company, Indianapolis, IN (US)

(72) Inventors: XiongBo Fu, Guangzhou (CN); Junxiang Luo, ShaoYang (CN)

(21) Appl. No.: 18/179,507

(22) Filed: Mar. 7, 2023

(30) Foreign Application Priority Data
Feb. 17, 2023 (CN) 202310135715.7

(51) Int. Cl. B05B 1/16

(52) U.S. Cl. CPC B05B 1/1663

(57) ABSTRACT

A hand shower including a handle supporting a water passageway and a sprayhead, and a user interface for controlling different cleaning modes from a cleaning nozzle assembly angularly offset from a sprayface.

### CROSS-REFERENCE TO RELATED APPLICATION

This application claims priority to Chinese Patent Application No. CN 202310135715.7, filed on Feb. 17, 2023, the disclosure of which is expressly incorporated herein by reference.

### BACKGROUND AND SUMMARY OF THE INVENTION

The present invention relates generally to a hand shower and, more particularly, to a hand shower including a sprayface and a nozzle assembly for providing different cleaning modes (e.g., a focused cleaning stream and a power clean spray).

Hand showers including a sprayface and a cleaning nozzle for cleaning a shower wall are known in the art. However, such conventional hand showers have failed to provide multiple cleaning functions, much less such cleaning functions controlled by a convenient user interface.

The present invention provides for a hand shower including a handle, a water passageway received within the handle, and a sprayface supported by the handle and including a plurality of water outlets in selective fluid communication with the water passageway. The hand shower further includes a cleaning nozzle assembly operably coupled to a user interface for toggling between different modes of operation, including a sprayhead mode, a deep clean stream mode and a power clean spray mode.

According to an illustrative embodiment of the present disclosure, a hand shower includes a handle, a water passageway received within the handle and defining a water inlet, and a sprayhead operably coupled to the handle and including a sprayface defining a longitudinal sprayhead axis, the sprayface having a plurality of water outlets. A cleaning nozzle assembly is supported by the sprayhead and includes a cleaning stream nozzle and a cleaning spray nozzle. A valve assembly is fluidly coupled to the water passageway. A user interface is operably coupled to the valve assembly to toggle the valve assembly between a plurality of modes of operation including a normal mode of operation, a first cleaning mode of operation and a second cleaning mode of operation. In the normal mode of operation, the water inlet is in fluid communication with the sprayface. In the first cleaning mode of operation, the water inlet is in fluid communication with the cleaning stream nozzle. In the second cleaning mode of operation, the water inlet is in fluid communication with the cleaning spray nozzle.

According to a further illustrative embodiment of the present disclosure, a hand shower includes a handle, a water passageway received within the handle and defining a water inlet, and a sprayhead operably coupled to the handle and including a sprayface defining a longitudinal sprayhead axis, the sprayface having a plurality of water outlets. A cleaning nozzle assembly is supported by the sprayhead and includes a cleaning stream nozzle and a cleaning spray nozzle. The cleaning nozzle assembly defines a longitudinal nozzle axis oriented at an angle between 45 degrees and 135 degrees from the first longitudinal axis of the sprayface. The cleaning stream nozzle includes a side wall having an inwardly tapering internal surface defining a stream passageway extending between an inlet opening and an outlet opening. The cleaning spray nozzle includes a side wall and an end wall defining a chamber receiving the outlet opening of the cleaning stream nozzle, the end wall including an outlet opening. The outlet opening of the cleaning stream nozzle is co-axially aligned with the outlet opening of the cleaning spray nozzle.

According to another illustrative embodiment of the present disclosure, a shower device includes a water passageway having a water inlet, and a sprayhead including a sprayface defining a longitudinal sprayhead axis, the sprayface having a plurality of water outlets. A cleaning nozzle assembly is supported by the sprayhead and includes a cleaning stream nozzle and a cleaning spray nozzle. A valve assembly is fluidly coupled to the water passageway. The valve assembly includes a valve housing, a first piston received within the valve housing to divert water to one of the cleaning spray nozzle or the cleaning stream nozzle, and a second piston received within the valve housing to divert water to the other of the cleaning stream nozzle or the cleaning spray nozzle. The first piston is movable with the valve housing between a first position and a second position, the first piston being in fluid communication with the second piston when in the first position, and the first piston being in fluid communication with one of the cleaning spray nozzle or the cleaning stream nozzle when in the second position. The second piston is movable within the valve housing between a first position and a second position, the second piston being in fluid communication with the sprayface when in the first position, and the second piston is in fluid communication with the other one of the cleaning stream nozzle or the cleaning spray nozzle when in the second position.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The following aspects and many of the intended advantages of this invention will become more readily appreciated as the same becomes better understood by reference to the following detailed description of exemplary embodiments when taken in conjunction with the accompanying drawings, wherein:

FIG. 1 is a front perspective view of an illustrative hand shower of the present disclosure;

FIG. 2 is a rear perspective view of the hand shower of FIG. 1;

FIG. 3 is a rear elevational view of the hand shower of FIG. 1;

FIG. 4 is a cross-sectional view taken along line 4-4 of FIG. 3;

FIG. 5 is a front partially exploded perspective view of the hand shower of FIG. 1;

FIG. 6 is a rear partially exploded perspective view of the hand shower of FIG. 1;

FIG. 7 is another front partially exploded perspective view of the hand shower of FIG. 1;

FIG. 8 is another rear partially exploded perspective view of the hand shower of FIG. 1;

FIG. 9 is a rear exploded perspective view of an illustrative valve assembly of the hand shower of FIG. 1;

FIG. 10 is a front exploded perspective view of the illustrative valve assembly of FIG. 9;

FIG. 11 is a detail of the cross-sectional view of FIG. 4, showing the valve assembly in a default mode with the first piston in a first position, and the second piston in a first position to direct water to the sprayface;

FIG. 12 is a detail of the cross-sectional view of FIG. 4, showing the valve assembly in a first cleaning mode with the first piston in the first position, and the second piston in a second position to direct water to the cleaning stream nozzle;

FIG. 13 is a cross-sectional view taken along line 13-13 of FIG. 3, showing the valve assembly in a second cleaning mode with the first piston in a second position, and the second piston in the first position to direct water to the cleaning spray nozzle;

FIG. 14 is a partial perspective view, in cross-section, of the hand shower of FIG. 1;

FIG. 15 is a cross-sectional view of an illustrative cleaning nozzle assembly of FIG. 14;

FIG. 16 is a perspective view in partial cross-section taken along line 16-16 of FIG. 2, showing internal details of the body of the valve assembly of FIG. 9; and

FIG. 17 is a perspective view in partial cross-section, showing internal details of the body of the valve assembly of FIG. 9.

Corresponding reference characters indicate corresponding parts throughout the several views. Although the drawings represent exemplary embodiments of the various features and components according to the present disclosure, the drawings are not necessarily to scale and certain features may be exaggerated in order to better illustrate exemplary embodiments of the invention, and such exemplifications are not to be construed as limiting the scope of the invention in any manner.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

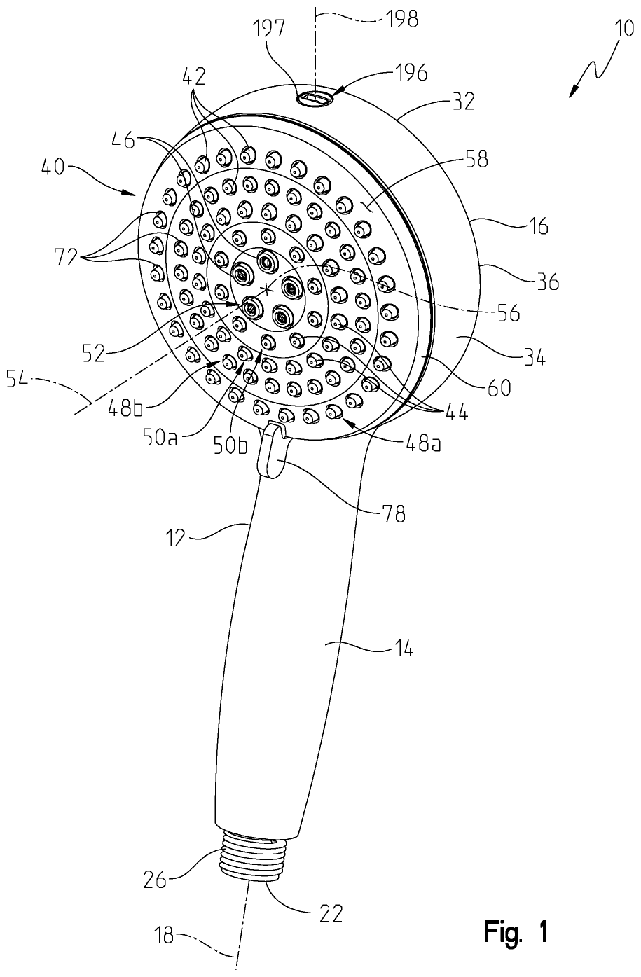

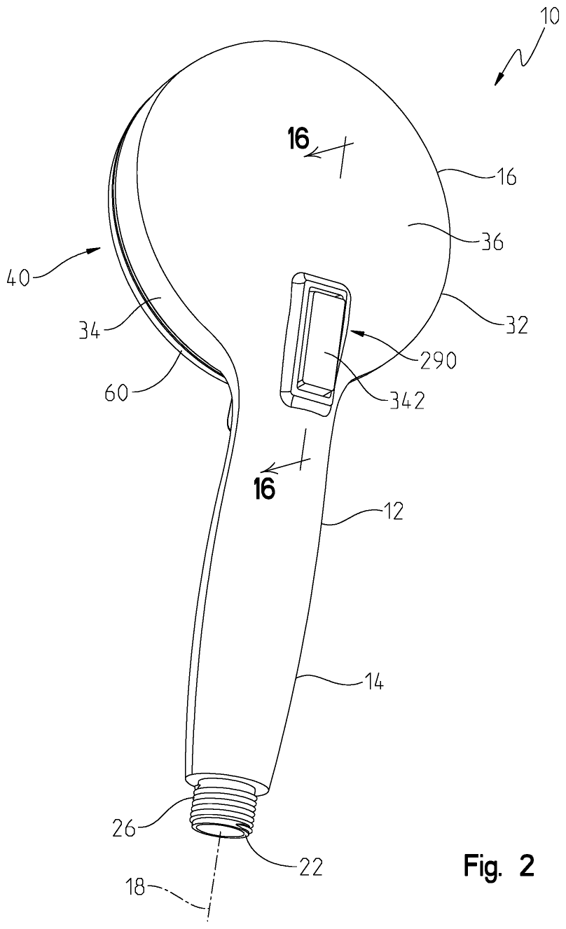

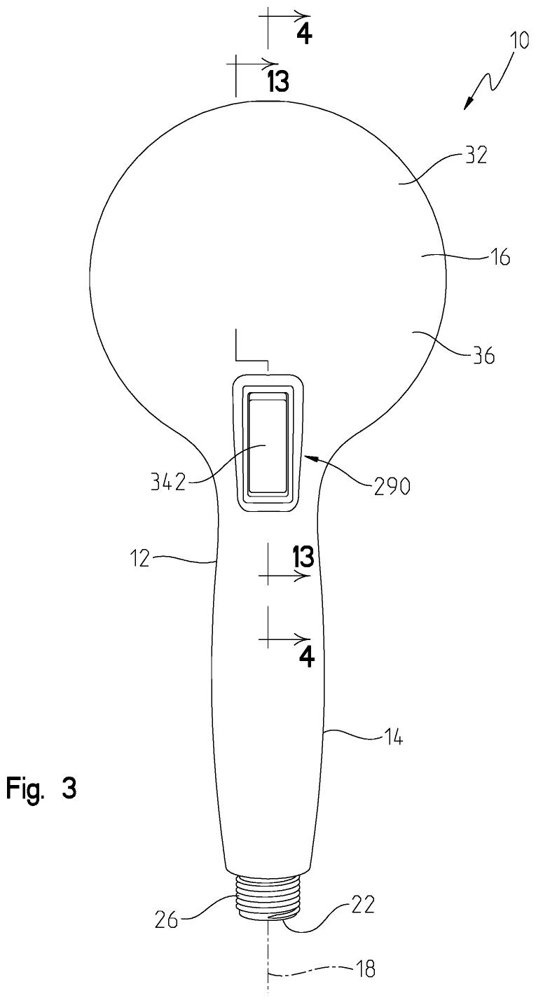

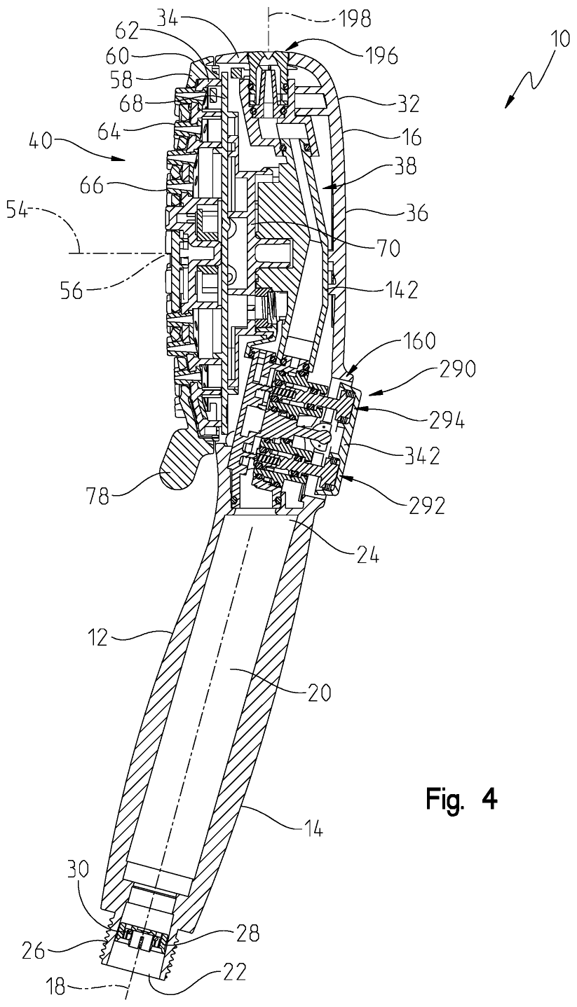

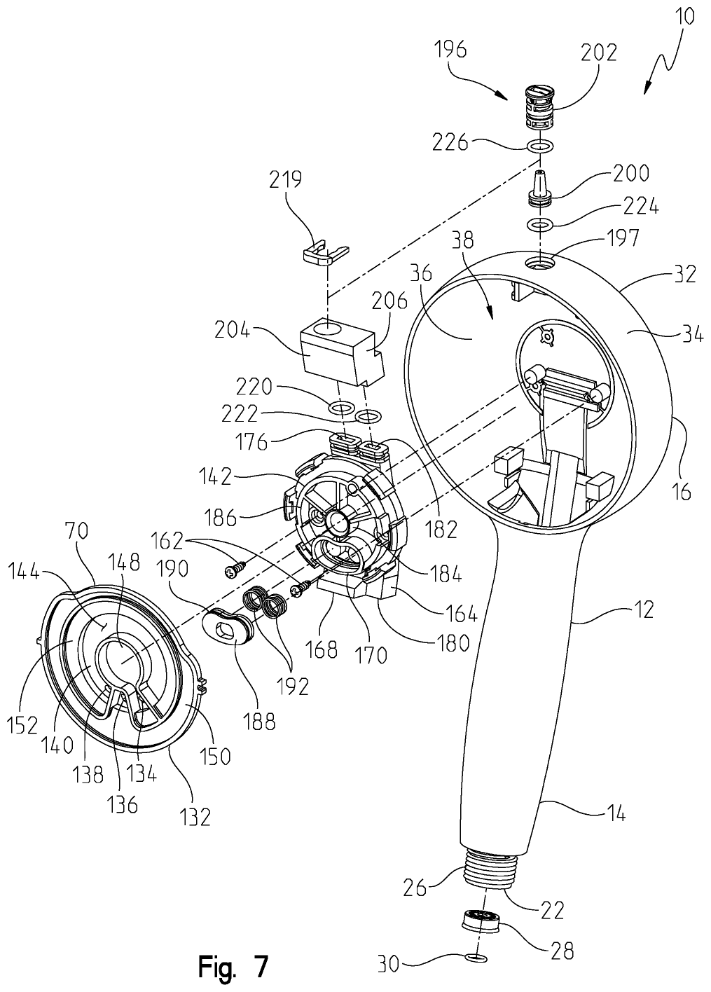

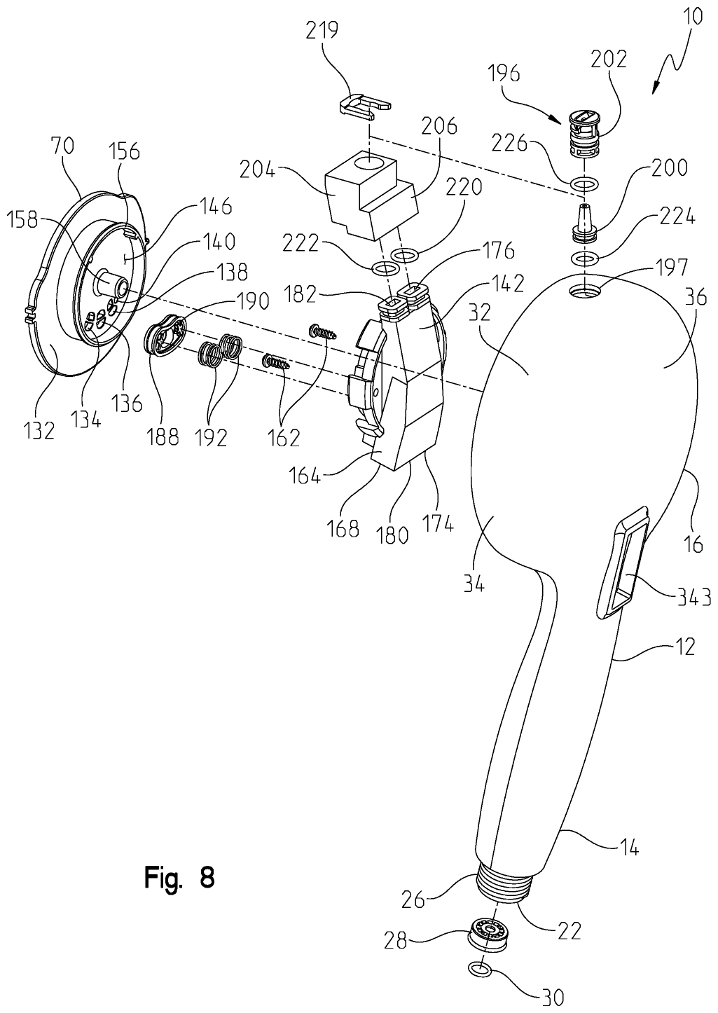

Referring initially to FIGS. 1-4, an illustrative shower device of the present disclosure is shown in the form of a hand shower 10 including a body 12 having a handle 14 supporting a sprayhead 16. In an illustrative embodiment, the body 12 may be molded as a unity body from a polymer, such as acrylonitrile butadiene styrene (ABS). The handle 14 extends along a longitudinal handle axis 18 and defines a water passageway 20 (FIG. 4). The water passageway 20 includes a water inlet 22 and a water outlet 24. A conventional fluid coupler 26 (e.g., a threaded connector) is secured to the water inlet 22 and is configured to fluidly couple with a conventional fitting of a flexible hose (not shown). A flow regulator 28 and an o-ring 30 are illustratively received within the water inlet 22 of the passageway 20 (FIGS. 7 and 8).

The illustrative sprayhead 16 includes a rear housing 32 defined by the body 12. The rear housing 32 includes a cylindrical side wall 34 extending forwardly from a rear wall 36. A chamber 38 is illustratively defined by the side wall 34 and the rear wall 36. A sprayface 40 is illustratively supported by the rear housing 32 and includes a plurality of water outlets 42, 44, 46. Illustratively, the water outlets 42, 44, 46 are circumferentially spaced in a plurality of concentric annular rings 48a, 48b, 50a, 50b and 52. More particularly, the water outlets 42 are arranged in outer annular rings 48a, 48b, the water outlets 44 are arranged in concentric intermediate annular rings 50a, 50b, and the water outlets 46 are arranged in concentric inner annual ring 52. It should be appreciated that the type, the number and the arrangement of water outlets 42, 44, 46 may vary.

With reference to FIGS. 1, 4 and 11, the sprayface 40 illustratively defines a longitudinal sprayhead axis 54 extending perpendicularly from proximate the center 56 of a front surface 58. The water outlets 42, 44, 46 are configured to discharge water forwardly and substantially parallel to the sprayhead axis 54.

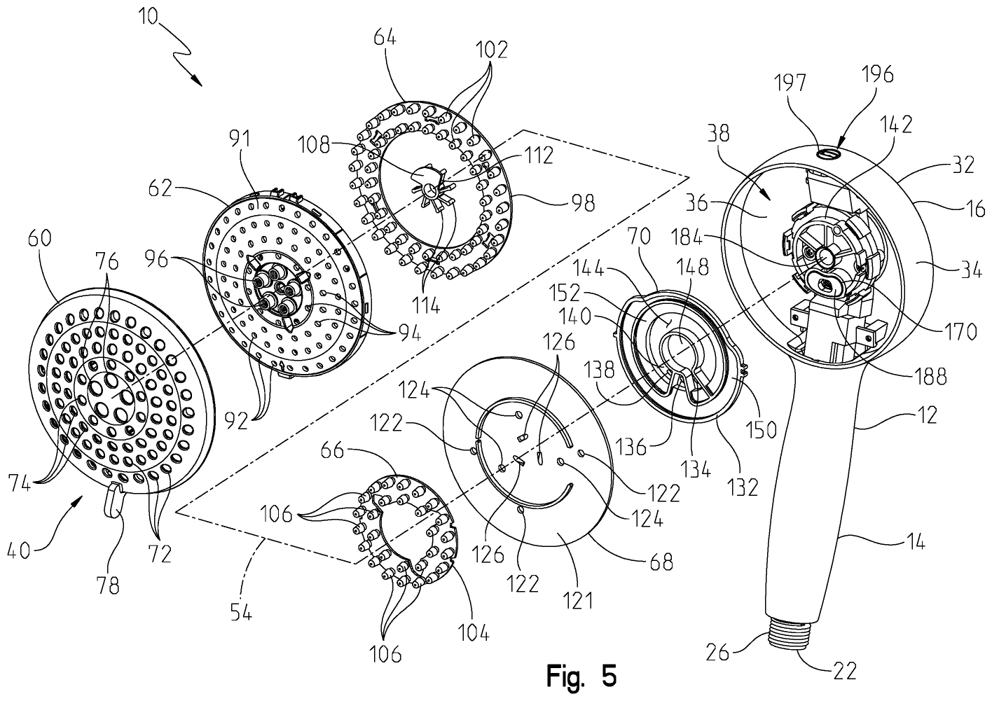

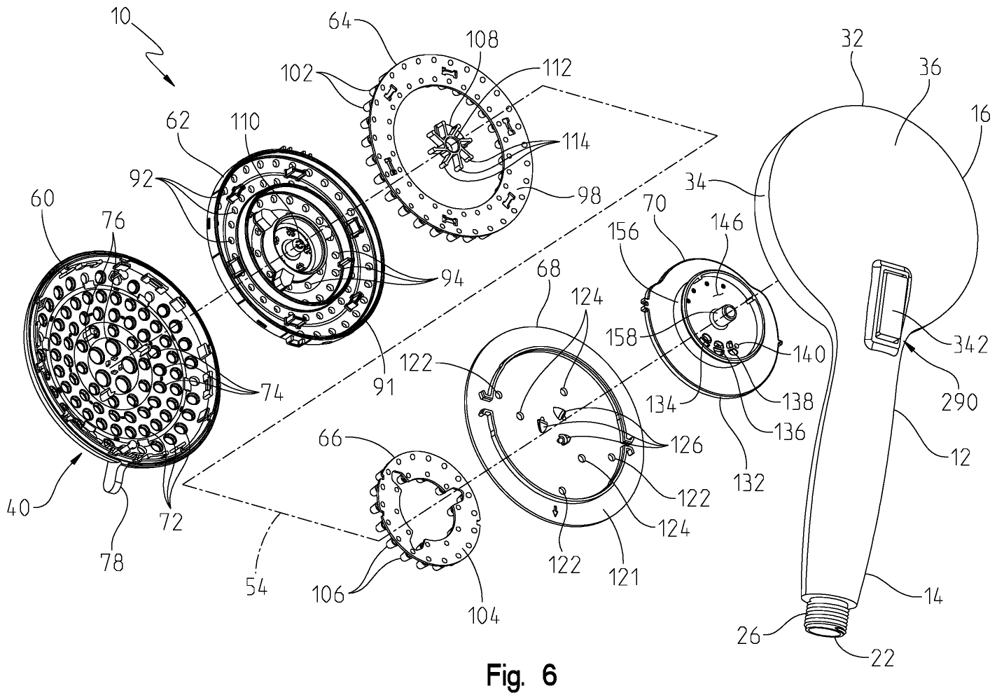

With reference now to FIGS. 5, 6 and 11, the sprayface 40 is illustratively of conventional design and includes an outer faceplate 60, a support member or hard nozzle assembly 62, an outer discharge member 64, an inner discharge member 66, a feeding plate 68, and a diverter member 70. The outer faceplate 60 may be molded from a polymer (e.g., acrylonitrile butadiene styrene (ABS)), and illustratively includes a plurality of circumferentially spaced openings 72, 74, 76 aligned with the water outlets 42, 44, 46. As further detailed herein, the outer discharge member 64 and the inner discharge member 66 are operably coupled to the support member 62 which, in turn, is operably coupled to the outer faceplate 60.

The feeding plate 68 is positioned inwardly from the support member 62, with the outer discharge member 64 and the inner discharge member 66 being positioned therebetween. The outer faceplate 60, the support member 62, the outer discharge member 64, the inner discharge member 66 and the feeding plate 68 are all coupled together to define the sprayface 40 for common rotation relative to the rear housing 32 about the sprayhead axis 54. A user interface tab 78 extends radially outwardly from the outer faceplate 60 to assist the user in rotating the sprayface 40.

With further reference to FIGS. 5, 6 and 11, the support member 62 is positioned inwardly from the outer faceplate 60 and illustratively includes a body 91 molded from a polymer, such as acrylonitrile butadiene styrene (ABS). The body 91 includes openings 92, 94, aligned with the openings 72, 74, respectively, of the outer faceplate 60. The support member 62 also includes nozzles 96 extending forwardly from the body 91 and received within the openings 76 of the outer faceplate 60 to define the water outlets 46.

The outer discharge member 64 includes a base 98 supporting a plurality of nozzles 102 aligned with the openings 92 of the support member 62 and the openings 72 of the outer faceplate 60. More particularly, the nozzles 102 extend axially forwardly through the openings 72, 92 to define the water outlets 42. The inner discharge member 66 includes a base 104 supporting a plurality of nozzles 106 aligned with the openings 94 of the support member 62 and the openings 74 of the outer faceplate 60. More particularly, the nozzles 106 extend axially forwardly through the openings 74, 94 to define the water outlets 44. Both the outer discharge member 64 and the inner discharge member 66 may be molded from a flexible material, such as a thermoplastic elastomer (TPE)

A turbine 108 may be operably coupled to the support member 62. More particularly, the illustrative turbine 108 is rotatably supported by a post 110 of the support member 62. The turbine 108 illustratively includes a body 112 formed of a polymer, such as an acetyl (POM) copolymer, and supporting a plurality of radially outwardly extending blades 114. The turbine 108 is in fluid communication with the nozzles 96 to dispense a pulsating water flow therethrough.

The illustrative feeding plate 68 includes a body 121 formed of a polymer (e.g., acrylonitrile butadiene styrene (ABS)), and illustratively includes a plurality of openings 122, 124, 126 in fluid communication with the water outlets 42, 44, 46, respectively. More particularly, the openings 122 are fluidly coupled to the nozzles 102 of the outer discharge member 64, the openings 124 are fluidly coupled to the nozzles 106 of the inner discharge member 66, and the openings 126 are fluidly coupled with the nozzles 96 of the support member 62.

With reference to FIGS. 5-8, the diverter member 70 is fluidly coupled to the feeding plate 68 for selectively supplying water from the water passageway 20 to the water outlets 42, 44, 46 of the sprayface 40. The diverter member 70 illustratively includes a body 132 molded from a polymer, such as acrylonitrile butadiene styrene (ABS). The diverter member 70 includes a plurality of circumferentially spaced openings 134, 136, 138, 140 formed within the body 132. The openings 134, 136, 138, 140 are in selective fluid communication with an upstream sprayhead waterway 142.

The openings 134, 136, 138, 140 illustratively extend between a front surface 144 and a rear surface 146 of the body 132 of the diverter member 70. In an illustrative embodiment, the openings 134, 136, 138 are in fluid communication with downstream channels 148, 150, 152, respectively, defined by the front surface 144 of the diverter member 70. Illustratively, the opening 140 has a smaller diameter then openings 134, 136, 138 for reduced flow therethrough to the channel 152. An annular wall 156 and a support post 158 extends rearwardly from the rear surface 146 of the body 132.

With further reference to FIGS. 7, 8 and 11, the sprayhead waterway 142 is illustratively received within the chamber 38 of the sprayhead 16 and fluidly couples the diverter member 70 to an upstream valve assembly 160. The sprayhead waterway 142 may be fixed to the rear wall 36 of the rear housing 32 via conventional means, such as adhesives, an interference fit and/or fasteners 162 (e.g., screws).

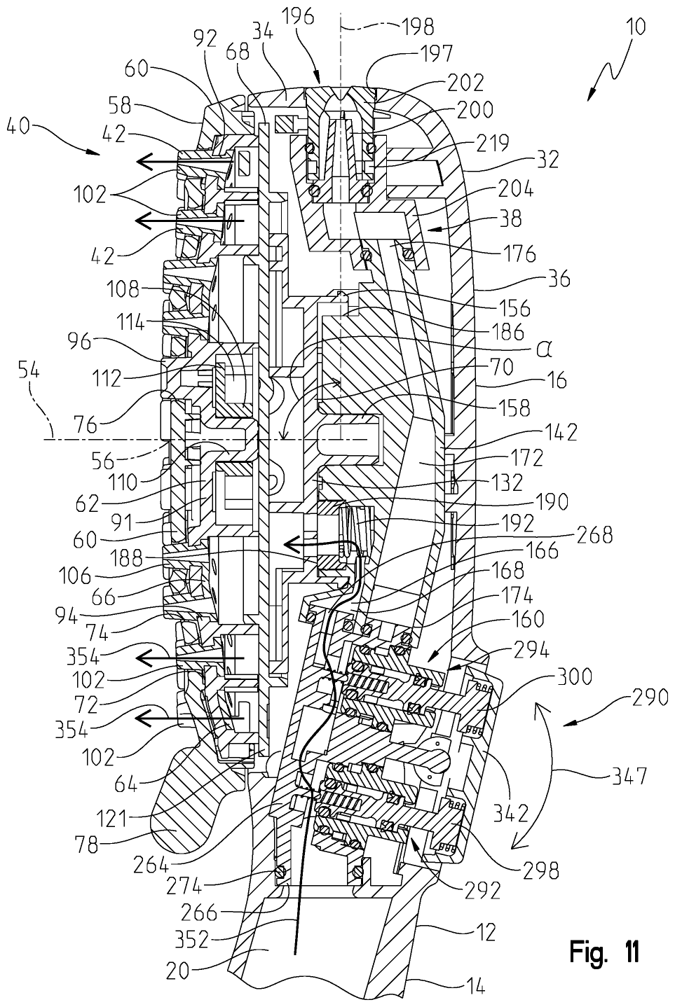

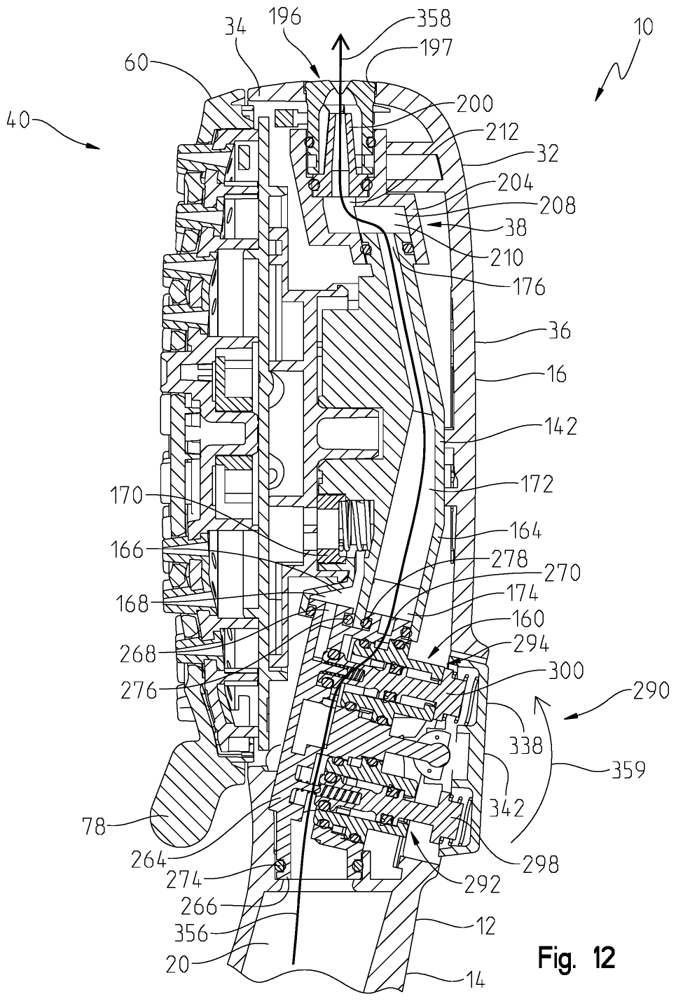

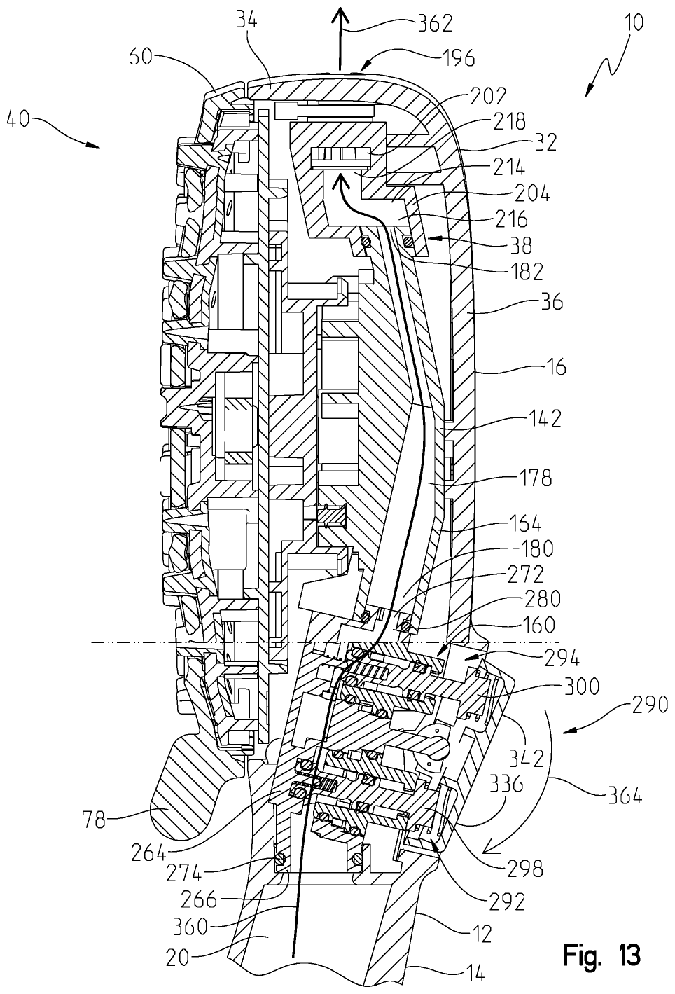

The sprayhead waterway 142 illustratively includes a body 164 formed of a polymer, such as an acetyl (POM) copolymer. The illustrative sprayhead waterway 142 includes a first channel 166 extending between an inlet 168 and an outlet 170 (FIGS. 11 and 12), a second channel 172 extending between an inlet 174 and an outlet 176 (FIGS. 11 and 12), and a third channel 178 extending between an inlet 180 and an outlet 182 (FIG. 13). An opening 184 is positioned proximate the outlet 170 of the first channel 166 and an annular support wall 186 extends around the opening 184. The opening 184 receives the support post 158 of the diverter member 70, wherein the diverter member 70 rotates relative to the sprayhead waterway 142. The annular wall 156 of the diverter member 70 extends around the support wall 186 to provide additional support therebetween.

The outlet 170 of the first channel 166 includes a seat 188 for interfacing with the diverter member 70. The seat 188 illustratively includes a seal or gasket 190 and cooperating springs 192 received within the outlet 170. The gasket 190 is illustratively formed of a flexible material, such as an elastomer (e.g., ethylene propylene diene monomer rubber (EPDM)). The springs 192 bias the gasket 190 toward the rear surface 146 of the diverter member 70 to provide a sliding seal therebetween.

The diverter member 70 is operably coupled to the sprayhead waterway 142 for changing the mode of operation of the sprayface 40 (e.g., active water outlets 42, 44, 46). More particularly, by rotating the sprayface 40, including the diverter member 70, the outlet 170 of the sprayhead waterway 142 aligns with different openings 134, 136, 138 of the diverter member 70 in order to cause different water outlets 42, 44, 46 to dispense water (i.e., become active). For example, when the opening 136 is fluidly coupled with the outlet 170, water outlets 42 may be active (e.g. a full spray mode) via the channel 150. When the opening 138 is fluidly coupled with the outlet 170, only certain water outlets 42 may be active (e.g., a shampoo mode) via the channel 152. When the opening 134 is fluidly coupled with the outlet 170, water outlets 46 may be active (e.g., a massage mode) via the channel 148. A pause mode may also be provided when the opening 140 is fluidly coupled with the outlet 170 where limited or no water is provided to the water outlets 42, 44, 46. More particularly, limited water may flow through the opening 140 to the channel 152. Again, cooperation between the diverter member 70 and the sprayhead waterway 142 may be of conventional design.

With reference to FIGS. 7, 8 and 11, a cleaning nozzle assembly 196 is also supported within an opening 197 in the side wall 34 of of the sprayhead 40 and defines a longitudinal nozzle axis 198. The nozzle axis 198 is illustratively oriented at an angle α relative to the sprayhead axis 54 (FIG. 11). The angle α is illustratively between 45 degrees and 135 degrees, and more particularly between 75 degrees and 105 degrees.

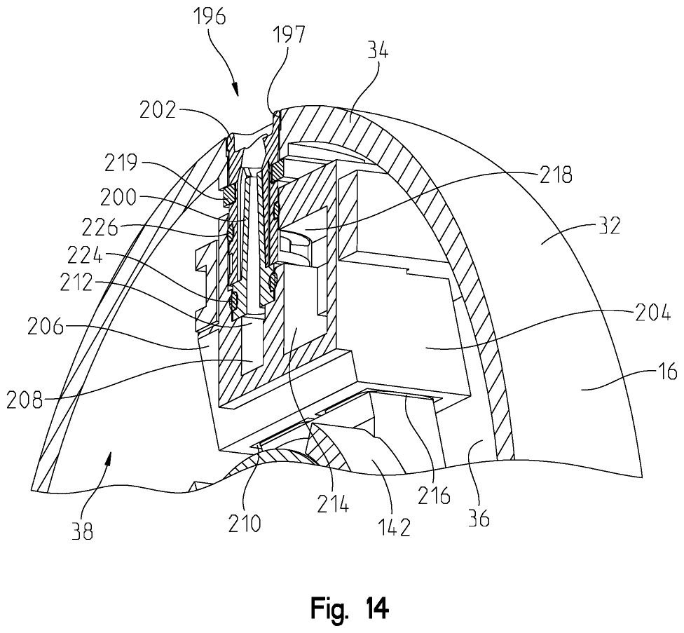

With reference to FIGS. 7, 8 and 14-16, the cleaning nozzle assembly 196 includes a cleaning stream nozzle 200 and a cleaning spray nozzle 202 received within a mounting member 204. The illustrative mounting member 204 includes a body 206 illustratively formed of a polymer, such as an acetyl (POM) copolymer. The mounting member 204 is supported within the chamber 38 of the sprayhead 40 and is fluidly coupled to the outlets 176 and 182 of the sprayhead waterway 142. More particularly, the body 206 illustratively includes a first passageway 208 extending between an inlet 210 and an outlet 212 (FIG. 12), and a second passageway 214 extending between an inlet 216 and an outlet 218 (FIG. 13). The inlet 210 is in fluid communication with the outlet 176 of the sprayhead waterway 142, and the inlet 216 is in fluid communication with the outlet 182 of the sprayhead waterway 142. The outlet 212 is in fluid communication with the cleaning stream nozzle 200, and the outlet 218 is in fluid communication with the cleaning spray nozzle 202 (FIG. 14).

With reference to FIGS. 7, 8 and 14, a clip 219 illustratively secures the cleaning spray nozzle 202 within the mounting member 204 thereby capturing the cleaning stream nozzle 200 therein. O-rings 220 and 222 illustratively seal the outlets 176 and 182 of the sprayhead waterway 142 to the inlets 210 and 216 of the mounting member 204. Illustratively, an o-ring 224 provides a seal between the cleaning stream nozzle 200 and the mounting member 204, and an o-ring 226 provides a seal between the cleaning spray nozzle 202 and the mounting member 204. The second channel 172 of the sprayhead waterway 142 is configured to communicate with the cleaning stream nozzle 200 via the first passageway 208 (FIG. 12), and the third channel 178 of the sprayhead waterway 142 is configured to communicate with the cleaning spray nozzle 202 via the second passageway 214 (FIG. 13).

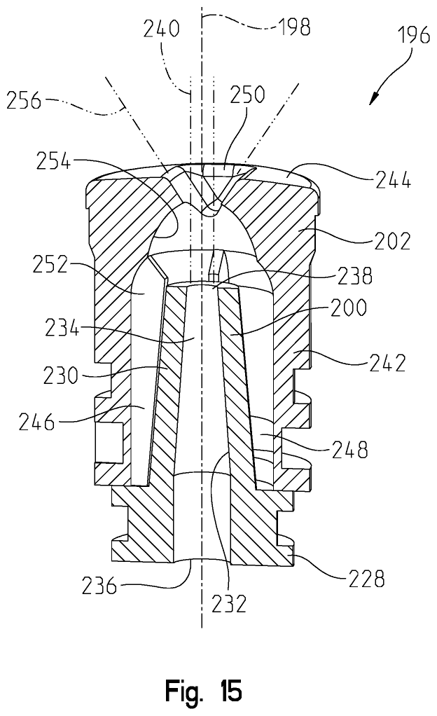

With reference to FIG. 15, the cleaning stream nozzle 200 is illustratively formed of a polymer, such as an acetyl (POM) copolymer. Illustratively, the cleaning stream nozzle 200 includes a mounting base 228 and a frusto-conical side wall 230 having an inwardly tapering internal surface 232 defining a stream passageway 234 extending between an inlet opening 236 and an outlet opening 238. The stream passageway 234 is configured to dispense a substantially laminar stream of water 240 from the outlet opening 238 extending substantially parallel to the nozzle axis 198 (i.e., a focused cleaning stream).

The cleaning spray nozzle 202 is illustratively formed of a polymer, such as an acetyl (POM) copolymer. Illustratively, the cleaning spray nozzle 202 includes a side wall 242 and an end wall 244 defining a chamber 246 receiving the outlet opening 238 of the cleaning stream nozzle 200. The side wall 242 includes radially extending inlet openings 248 in fluid communication with the chamber 246. The end wall 244 includes an outlet opening 250 co-axially aligned with the outlet opening 238 of the cleaning stream nozzle 200 along the nozzle axis 198. A spray passageway 252 is defined between the side wall 230 of the cleaning stream nozzle 200 and the side wall 242 of the cleaning spray nozzle 202, and extends between the inlet opening 248 and the outlet opening 238. The spray passageway 252 is configured to dispense a fan of water. More particularly, an inner surface 254 of the side wall 242 is configured to facilitate formation of a fan spray of water 256 from the outlet opening 238 extending radially outwardly from the nozzle axis 198 (i.e., a power clean spray).

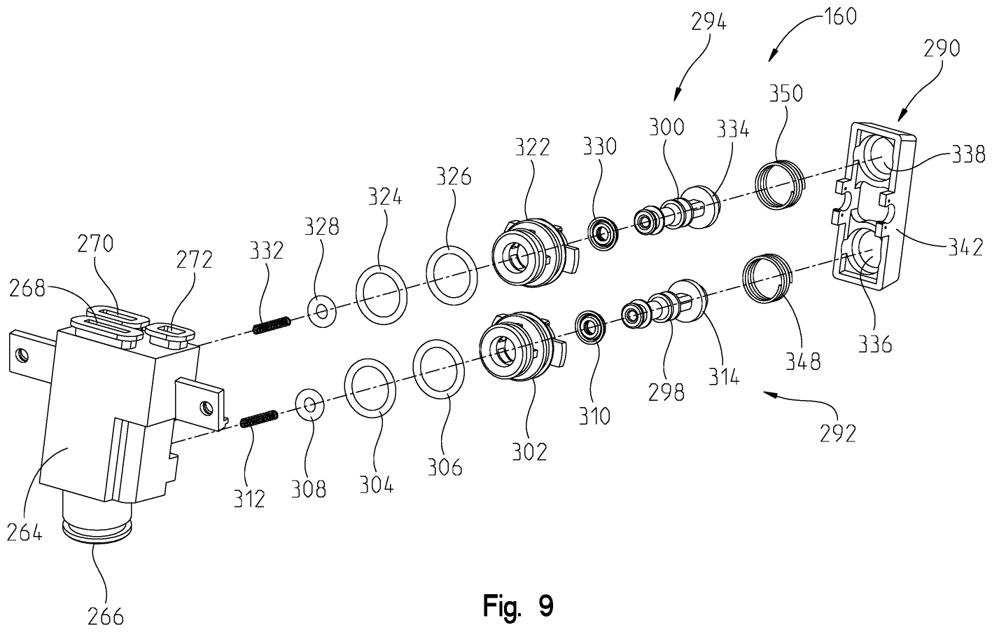

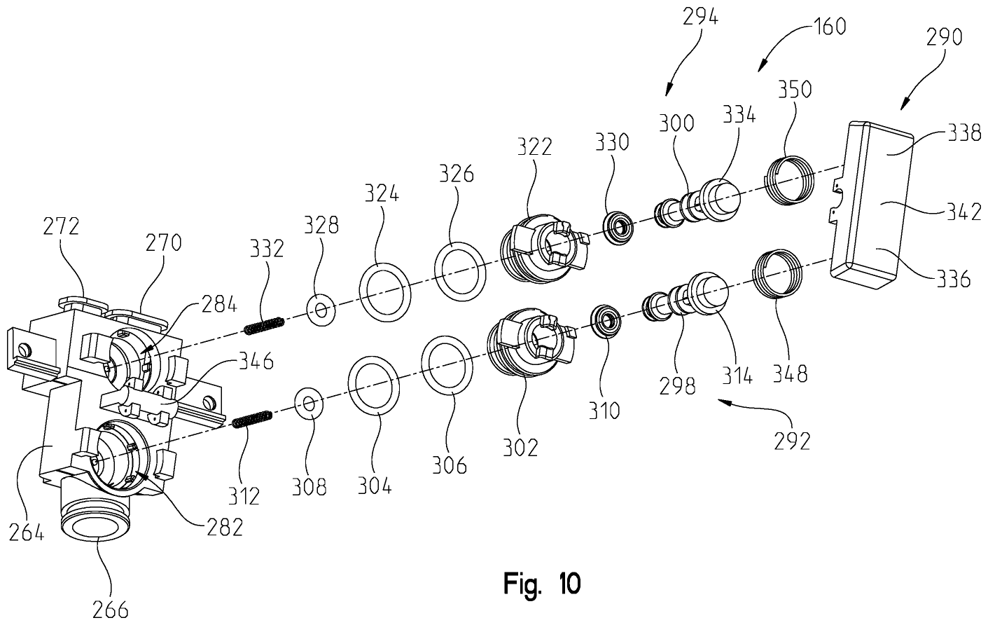

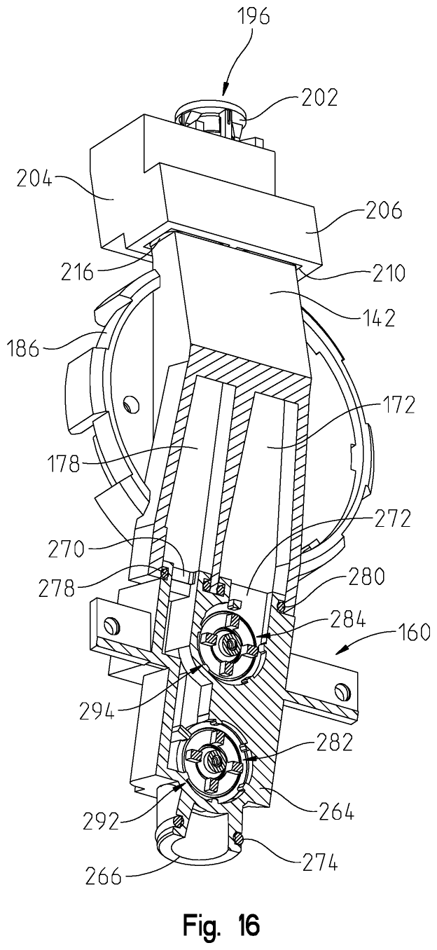

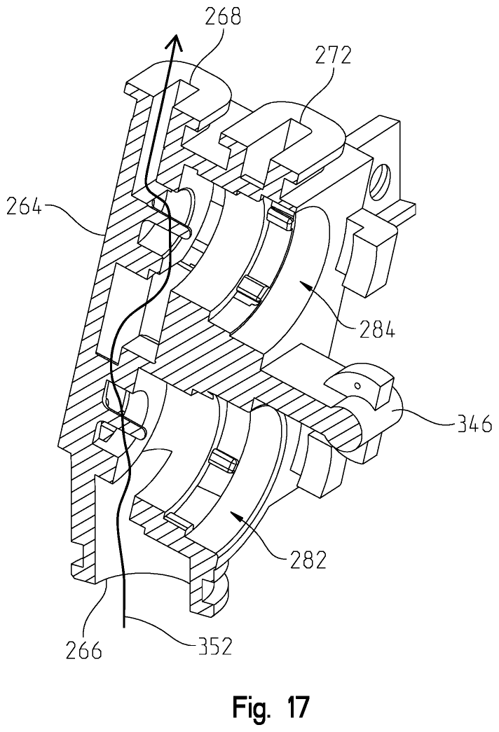

With reference now to FIGS. 9-13, 16 and 17, the illustrative valve assembly 160 includes a valve body 264 formed of a polymer, such as an acetyl (POM) copolymer. The valve body 264 illustratively includes an inlet 266 in selective fluid communication with a first outlet 268 (FIG. 11), a second outlet 270 (FIG. 12) and a third outlet 272 (FIG. 13). The inlet 266 of the valve body 264 is fluidly coupled to the outlet 24 of the water passageway 20. The first outlet 268 is fluidly coupled to the inlet 168 of the first channel 166 of the sprayhead waterway 142, the second outlet 270 is fluidly coupled to the inlet 174 of the second channel 172 of the sprayhead waterway 142, and the third outlet 272 is fluidly coupled to the inlet 180 of the third channel 178 of the sprayhead waterway 142. O-rings 274, 276, 278 and 280 are coupled to the inlet 266, the first outlet 268, the second outlet 270 and the third outlet 272, respectively (FIG. 16). First and second receiving bores 282 and 284 are formed within the body 264 between the inlet 266 and the outlets 268, 270, 272 (FIGS. 10, 16 and 17).

A user interface 290 is operably coupled to the valve assembly 160 to toggle the valve assembly 160 between a plurality of modes of operation in response to a user input. These modes of operation include a default or normal mode of operation, a first cleaning mode of operation, and a second cleaning mode of operation.

The illustrative valve assembly 160 includes a first valve 292 and a second valve 294 supported by the valve body 264. The first valve 292 is illustratively a momentary valve including a spring biased first piston 298 received within the first receiving bore 282 and movable from a first or default positon (directing water to the second valve 294)(FIGS. 11 and 12) to a second position (directing water to the third outlet 272)(FIG. 13). Similarly, the second valve 294 is illustratively a momentary valve including a spring biased second piston 300 movable from a first or default position (directing water to the first outlet 268)(FIG. 11) and a second position (directing water to the second outlet 270)(FIG. 12).

More particularly, the first piston 298 is slidably received within a sleeve 302 which, in turn, is received within the first bore 282 of the valve body 264 to divert water to either the second piston 300 (FIGS. 11 and 12) or to the cleaning spray nozzle 202 (FIG. 13). O-rings 304 and 306 are supported by the sleeve 302, and o-rings 308 and 310 are supported by the first piston 298. A spring 312 is operably coupled to a first end of the first piston 298, and a cap 314 is supported by the second end of the first piston 298 to providing sliding seals with the sleeve 302. The first piston 298 is movable within the valve body 264 between a first (or default) position and a second (or active) position. The first piston 298 is in fluid communication with the second piston 300 when in the first position (FIG. 11). As further detailed herein, the first piston 298 is axially moved inwardly from the first position to the second position as a result of a force applied (e.g., pressing) by a user. The first piston 298 is in fluid communication with the cleaning spray nozzle 202 when in the second position (FIG. 12). The first spring 312 biases the first piston 298 toward the first position.

Similarly, the second piston 300 is slidably received within a sleeve 322 which, in turn, is received within the second bore 284 of the valve body 264 to divert water to either the cleaning stream nozzle 200 (FIG. 12). O-rings 324 and 326 are supported by the sleeve 322 to seal with the valve body 204, and o-rings 328 and 330 are supported by the second piston 300 to provide sliding seals with the sleeve 322. A spring 332 is operably coupled to a first end of the second piston 260, and a cap 334 is supported by the second end of the second piston 300. The second piston 260 is movable within the valve body 264 between a first (or default) positon and a second (or active) position. As further detailed herein, the second piston 300 is axially moved inwardly from the first position to the second position as a result of a force applied (e.g., pressing) by a user. The second piston 300 is in fluid communication with the sprayface 40 when in the first position (FIG. 11). The second piston 300 is in fluid communication with the cleaning stream nozzle 200 when in the second position (FIG. 12). The second spring 332 biases the second piston 300 toward the first position.

With reference to FIGS. 9-13, the user interface 290 illustratively includes a first input button 338 operably coupled to the first piston 298, and a second input button 338 operably coupled to the second piston 300. Illustratively, a rocker switch 342 defines the first input button 338 and the second input button 340. The rocker switch 342 is pivotably supported by the valve body 264 and extends through an opening 343 (FIG. 8) formed in the body 12 of the hand shower 10. More particularly, a pivot coupling 346 supports the rocker switch 342 on the valve body 264. As such, the rocker switch 342 can pivot between first and second positions (as represented by arrows 347 in FIG. 11). Springs 348 and 350 cooperate with the springs 312 and 332 to bias the rocker switch 342 to a default or normal position as shown in FIG. 11.

In operation, the illustrative user interface 290, in response to user input, is configured to toggle the valve assembly 160 between the default or normal mode of operation, the first cleaning mode of operation and the second cleaning mode of operation. FIG. 11 illustrates the normal mode of operation where water from the passageway 20 flows to the sprayface 40, as shown by flow arrows 352 and 354. More particularly, both the first piston 298 and the second piston 300 are in their respective first positions. Water 352 flows from the passageway 20 into the valve body 264 via the inlet 266, then past the first piston 298 via the sleeve 302 and the receiving bore 282, and past the second piston 300 via the sleeve 322 and the receiving bore 284. Water 352 flows through the first outlet 268 of the valve body 264 into the first channel 166 of the sprayhead waterway 142. Water 352 then flows out of the outlet 170 of the sprayhead waterway 142 to the sprayface 40 via the diverter member 70, As further detailed herein, the rotational position of the diverter member 70 determines which, if any, of the water outlets 42, 44, 46 are dispensing water 354 (i.e., active). In the position shown in FIG. 11, the water outlets 42 defined by nozzles 102 are dispensing water 354.

FIG. 12 illustrates the first cleaning mode of operation where the rocker switch 342 is pivoted counter-clockwise from the position of FIG. 11, as shown by arrow 359. In this first cleaning mode, water from the passageway 20 flows to the cleaning stream nozzle 194, as shown by flow arrows 356 and 358. More particularly, the first piston 298 remains in its first position, and the second piston 300 has been moved to its second position by being forced axially inwardly by a user pressing on the second input button 338 of the rocker switch 342. In this mode, water 356 flows from the passageway 20 into the valve body 264 via the inlet 266, and flows past the first piston 298 via the sleeve 302 and the receiving bore 282 to the second piston 300. In the second position of the second piston 300, water flows through the sleeve 332 through the second outlet 270 of the valve body 264 into the second channel 172 of the sprayhead waterway 142. The water 356 then flows out of the outlet 176 of the sprayhead waterway 142 to the cleaning stream nozzle 200 of the cleaning nozzle assembly 196. As further detailed herein, water 356 flows through the stream passageway 234 of the cleaning stream nozzle 200 where it is discharged from the outlet opening 238 as a focused cleaning stream 358.

FIG. 13 illustrates the second cleaning mode of operation where the rocker switch 342 is pivoted clockwise from the position of FIG. 11, as shown by arrow 364. In this second cleaning mode, water from the passageway 20 flows to the cleaning spray nozzle 202, as shown by flow arrows 360 and 362. More particularly, the first piston 298 has been moved to its second position by being forced axially inwardly by a user pressing on the first input button 336 of the rocker switch 342, while the second piston 300 remains in its first position. In the mode, water 360 flows from the passageway 20 into the valve body 264 via the inlet 266, and is diverted to the third outlet 272 of the valve body 264. Water 360 then flows through the third channel 178 of the sprayhead waterway 142 to the cleaning spray nozzle 202 of the cleaning nozzle assembly 196. As further detailed herein, water 360 flows through the spray passageway 252 of the cleaning spray nozzle 202 where it is discharged from the outlet opening 238 as a fan spray 362.

Upon releasing the rocker switch 342 from the positions of FIG. 12 or 13, it automatically returns to the default position of FIG. 11. More particularly, the springs 312, 348 and 332, 350 bias the first piston 298 and the second piston 300, along with the cooperating rocket switch 342, to the default position. In other words, upon the user releasing the rocker switch 342 of the illustrative embodiment, the valve assembly 160 automatically returns to the default or normal mode of operation where water flows to the sprayface 40. However, in other illustrative embodiments, the valve assembly 160 may maintain its current mode of operation upon releasing the rocker switch 342, wherein the user must toggle the rocker switch 342 to a different position (e.g., depress an opposite side of the rocker switch 342) to change the mode of operation.

Water flowing along the pathway defines a power clean spray mode, where water exits as a fan spray of water 256 (FIG. 15) from the outlet opening 238. Water flowing along the pathway defines a laser spray or focused cleaning stream mode, where water exits as a substantially laminar stream 240 (FIG. 15) through an inner opening or outlet.

Operation of the hand shower facilitates water flow through two independent water ways or pathways: the first pathway for the power clean spray mode, and the second pathway for the focused cleaning stream mode. When the first valve 212 is depressed by a user, the power clean spray mode is activated and water passes through the outer opening of the water outlet along the pathway. Upon releasing the first valve 212, water is blocked from flowing along the pathway. When the second valve 214 is depressed by the user the laser or the focused cleaning stream mode is activated and water passes through the inner opening of the water outlet along the pathway. Upon releasing the second valve 214, water is blocked from flowing along the pathway.

Although the invention has been described in detail with reference to certain preferred embodiments, variations and modifications exist within the spirt and scope of the invention as described and defined in the following claims.

1. A hand shower comprising:
a handle;
a water passageway received within the handle and defining a water inlet;
a sprayhead operably coupled to the handle and including a sprayface defining a longitudinal sprayhead axis, the sprayface having a plurality of water outlets;
a cleaning nozzle assembly supported by the sprayhead, the cleaning nozzle assembly including a cleaning stream nozzle and a cleaning spray nozzle;
a valve assembly fluidly coupled to the water passageway;
a user interface operably coupled to the valve assembly to toggle the valve assembly between a plurality of modes of operation including a normal mode of operation, a first cleaning mode of operation and a second cleaning mode of operation;
wherein in the normal mode of operation, the water inlet is in fluid communication with at least some of the plurality of water outlets of the sprayface;
wherein in the first cleaning mode of operation, the water inlet is in fluid communication with the cleaning stream nozzle; and
wherein in the second cleaning mode of operation, the water inlet is in fluid communication with the cleaning spray nozzle.

2. The hand shower of claim 1, wherein the cleaning nozzle assembly defines a longitudinal nozzle axis oriented at an angle of between 45 degrees and 135 degrees from the first longitudinal axis of the sprayface.

3. The hand shower of claim 1, further comprising a selector operably coupled to the sprayface and configured to change the water outlets in fluid communication with the water inlet when the valve assembly is in the normal mode of operation.

4. The hand shower of claim 1, wherein:
the cleaning stream nozzle includes a side wall having an inwardly tapering internal surface defining a stream passageway extending between an inlet opening and an outlet opening;
the cleaning spray nozzle includes a side wall and an end wall defining a chamber receiving the outlet opening of the cleaning stream nozzle, the end wall including an outlet opening; and
the outlet opening of the cleaning stream nozzle is co-axially aligned with the outlet opening of the cleaning spray nozzle.

5. The hand shower of claim 1, wherein the valve assembly includes:
a valve housing;
a first piston received within the valve housing to divert water to the cleaning spray nozzle; and
a second piston received within the valve housing to divert water to the cleaning stream nozzle.

6. The hand shower of claim 5, wherein:
the first piston is movable within the valve housing between a first position and a second position, the first piston is in fluid communication with the second piston when in the first positon, and the first piston is in fluid communication with the cleaning spray nozzle when in the second position; and
the second piston is movable within the valve housing between a first position and a second position, the second piston is in fluid communication with the sprayface when in the first position, and the second piston is in fluid communication with the cleaning stream nozzle when in the second position.

7. The hand shower of claim 6, further comprising a first spring biasing the first piston toward the first position, and a second spring biasing the second piston toward the first position.

8. The hand shower of claim 5, wherein the user interface includes a first momentary input button operably coupled to the first piston, and a second momentary input button operable coupled to the second piston.

9. The hand shower of claim 8, wherein the user interface includes a rocker switch pivotably supported by the valve housing, the rocker switch defining the first momentary input button and the second momentary input button.

10. The hand shower of claim 1, wherein the cleaning steam nozzle in the first cleaning mode of operation discharges a substantially laminar stream of water, and the cleaning spray nozzle in the second cleaning mode of operation discharges a fan spray of water.

11. A hand shower comprising:
a handle;
a water passageway received within the handle and defining a water inlet;
a sprayhead operably coupled to the handle and including a sprayface defining a longitudinal sprayhead axis, the sprayface having a plurality of water outlets;
a cleaning nozzle assembly supported by the sprayhead, the cleaning nozzle assembly including a cleaning stream nozzle and a cleaning spray nozzle;
wherein the cleaning nozzle assembly defines a longitudinal nozzle axis oriented at an angle of between 45 degrees and 135 degrees from the longitudinal nozzle axis of the sprayface;
the cleaning stream nozzle including a side wall having an inwardly tapering internal surface defining a stream passageway extending between an inlet opening and an outlet opening;
the cleaning spray nozzle including a side wall and an end wall defining a chamber receiving the outlet opening of the cleaning stream nozzle, the end wall including an outlet opening; and
wherein the outlet opening of the cleaning stream nozzle is co-axially aligned with the outlet opening of the cleaning spray nozzle.

12. The hand shower of claim 11, further comprising:
a valve assembly fluidly coupled to the water passageway;
a user interface operably coupled to the valve assembly to toggle the valve assembly between a plurality of modes of operation including a normal mode of operation, a first cleaning mode of operation and a second cleaning mode of operation;
wherein in the normal mode of operation, the water inlet is in fluid communication with at least some of the plurality of water outlets of the sprayface;
wherein in the first cleaning mode of operation, the water inlet is in fluid communication with the cleaning stream nozzle; and
wherein in the second cleaning mode of operation, the water inlet is in fluid communication with the cleaning spray nozzle.

13. The hand shower of claim 12, further comprising a selector operably coupled to the sprayface and configured to change the water outlets in fluid communication with the water inlet when the valve assembly is in the normal mode of operation.

14. The hand shower of claim 11, wherein the longitudinal nozzle axis of the cleaning nozzle assembly is oriented at an angle of between 75 degrees and 105 degrees from the longitudinal sprayhead axis of the sprayface.

15. The hand shower of claim 11, wherein the valve assembly includes:
a valve housing;
a first piston received within the valve housing to divert water to the cleaning spray nozzle; and
a second piston received within the valve housing to divert water to the cleaning stream nozzle.

16. The hand shower of claim 15, wherein:
the first piston is movable within the valve housing between a first position and a second position, the first piston is in fluid communication with the second piston when in the first positon, and the first piston is in fluid communication with the cleaning spray nozzle when in the second position; and
the second piston is movable within the valve housing between a first position and a second position, the second piston is in fluid communication with the sprayface when in the first position, and the second piston is in fluid communication with the cleaning stream nozzle when in the second position.

17. The hand shower of claim 16, further comprising a first spring biasing the first piston toward the first position, and a second spring biasing the second piston toward the first position.

18. The hand shower of claim 15, wherein the user interface includes a first momentary input button operably coupled to the first piston, and a second momentary input button operable coupled to the second piston.

19. The hand shower of claim 18, wherein the user interface includes a rocker switch pivotably supported by the valve housing, the rocker switch defining the first momentary input button and the second momentary input button.

20. The hand shower of claim 11, wherein the cleaning steam nozzle in the first cleaning mode of operation discharges a substantially laminar stream of water, and the cleaning spray nozzle in the second cleaning mode of operation discharges a fan spray of water.

21. A shower device comprising:
a water passageway including a water inlet;
a sprayhead including a sprayface defining a longitudinal sprayhead axis, the sprayface having a plurality of water outlets;
a cleaning nozzle assembly supported by the sprayhead, the cleaning nozzle assembly including a cleaning stream nozzle and a cleaning spray nozzle;
a valve assembly fluidly coupled to the water passageway, the valve assembly including:
a valve housing;
a first piston received within the valve housing to divert water to the cleaning spray nozzle;
a second piston received within the valve housing to divert water to the cleaning stream nozzle;
wherein the first piston is movable within the valve housing between a first position and a second position, the first piston is in fluid communication with the second piston when in the first positon, and the first piston is in fluid communication with one of the cleaning spray nozzle or the cleaning stream nozzle when in the second position; and
wherein the second piston is movable within the valve housing between a first position and a second position, the second piston is in fluid communication with the sprayface when in the first position, and the second piston is in fluid communication with the other one of the cleaning stream nozzle or the cleaning spray nozzle when in the second position.

22. The shower device of claim 21, further comprising:
a user interface operably coupled to the valve assembly to toggle the valve assembly between a plurality of modes of operation including a normal mode of operation, a first cleaning mode of operation and a second cleaning mode of operation;
wherein in the normal mode of operation, the water inlet is in fluid communication with the sprayface;
wherein in the first cleaning mode of operation, the water inlet is in fluid communication with the cleaning stream nozzle; and
wherein in the second cleaning mode of operation, the water inlet is in fluid communication with the cleaning spray nozzle.

23. The shower device of claim 22, further comprising a selector operably coupled to the sprayface and configured to change the water outlets in fluid communication with the water inlet when the valve assembly is in the normal mode of operation.

24. The shower device of claim 21, further comprising a handle, the water passageway received within the handle and defining the water inlet, and the sprayhead supported by the handle.

25. The shower device of claim 21, wherein the longitudinal nozzle axis of the cleaning nozzle assembly is oriented at an angle of between 45 degrees and 135 degrees from the longitudinal sprayhead axis of the sprayface.

26. The shower device of claim 21, wherein:
the cleaning stream nozzle includes a side wall having an inwardly tapering internal surface defining a stream passageway extending between an inlet opening and an outlet opening;
the cleaning spray nozzle includes a side wall and an end wall defining a chamber receiving the outlet opening of the cleaning stream nozzle, the end wall including an outlet opening; and
the outlet opening of the cleaning stream nozzle is co-axially aligned with the outlet opening of the cleaning spray nozzle.

27. The shower device of claim 21, further comprising a first spring biasing the first piston toward the first position, and a second spring biasing the second piston toward the first position.

28. The shower device of claim 21, wherein the user interface includes a first momentary input button operably coupled to the first piston, and a second momentary input button operable coupled to the second piston.

29. The shower device of claim 28, wherein the user interface includes a rocker switch pivotably supported by the valve housing, the rocker switch defining the first momentary input button and the second momentary input button.

30. The shower device of claim 21, wherein the cleaning steam nozzle in the first cleaning mode of operation discharges a substantially laminar stream of water, and the cleaning spray nozzle in the second cleaning mode of operation discharges a fan spray of water.
